(19) United States
(12) Patent Application Publication
(10) Pub. No.: US 2024/0397262 A1
(43) Pub. Date: Nov. 28, 2024

(54) MULTI-CHANNEL SPEAKER SYSTEM AND METHOD THEREOF

(71) Applicant: HARMAN INTERNATIONAL INDUSTRIES, INCORPORATED, Stamford, CT (US)

(72) Inventors: Jianwen ZHENG, Shenzhen (CN); Shao-Fu SHIH, Mountain View, CA (US)

(73) Assignee: HARMAN INTERNATIONAL INDUSTRIES, INCORPORATED, Sttamford, CT (US)

(21) Appl. No.: 18/764,438

(22) Filed: Jul. 5, 2024

Related U.S. Application Data
(63) Continuation of application No. PCT/CN22/70062, filed on Jan. 4, 2022.

(51) Int. Cl. H04R 3/12; H04R 5/02; H04R 5/027; H04R 5/04

(52) U.S. Cl. CPC H04R 3/12; H04R 5/02; H04R 5/027; H04R 5/04; H04R 2201/401; H04R 2203/12; H04R 2205/024

(57) ABSTRACT

The disclosure describes a method for a multi-channel speaker system including N speakers. The method may comprise obtaining N! permutations of channel sequence for the N speakers; determining, for each permutation, a voting score that represents the matching degree between the channel sequence indicated in a permutation and a correct channel assignment sequence of the N speakers; selecting the permutation with the highest voting score; and assigning input source channels to the N speakers in the order of the channel sequence indicated in the selected permutation.

### CROSS-REFERENCE TO RELATED APPLICATION

This application is a continuation of International Application No. PCT/CN22/070062, filed on Jan. 4, 2022, the disclosure of which is incorporated by reference herein.

### TECHNICAL FIELD

The present disclosure relates to a method for a multi-channel speaker system and the multi-channel speaker system, and specifically relates to the method of automatic detection of speaker positions and automatic assignments for arbitrarily placed multi-channel speaker system, as well as the multi-channel speaker system.

### BACKGROUND

Multi-channel speaker systems are becoming increasingly popular as one of options for the modern integrated home entertainment system. These multi-channel speaker systems are commonly used to provide immersive audio experiences for movies and multi-channel audio reproduction such as the Dolby ATMOS Music.

With the advancement of wireless technologies, companies have launched their own wireless audio ecosystem to allow user to link a certain number of speakers together to form a mesh network. The common configurations are four portable speakers regarded as a 4.0 channel system, or a soundbar with two portable speakers as true surround setup such as 5.1/7.1 channel systems.

For users' convenience and room tidiness, the linked speakers in the ecosystem usually rely on wireless audio transmission to transmit audio signals, hence without the need of external wires connected to each other. While reducing the need of unnecessary wires, this will require extra speaker position identification during the setup process.

To detect speaker position and thus correctly assign the source channel to the corresponding speaker in various rooms and setups, most multi-channel speaker systems provide acoustic calibration for the system.

Normally the calibration is performed by in-situ measurements via the speaker and microphone. Some calibration methods require an external microphone. For example, some multi-speaker systems require an additional device with microphones for performing calibration. The frequency response of each speaker will be adjusted after the calibration, but there is no automatic speaker assignment correction. For example, some multi-speaker system asks user to manually assign the speaker position before calibration. In this case, failing to assign the correct channel sequence will lead to the reversed sound image even after calibration.

Other calibration methods are using internal microphone, which is friendlier to user, but there is still no automatic speaker assignment correction. Taking a system containing four separate speakers as an example, the calibration method takes advantage of all microphones in each speaker to detect if left and right speakers are reversed, or left surround and right surround speakers are reversed, respectively, but if they are both reversed, the detection algorithm of the calibration method will not be able to react.

Therefore, it is necessary to provide a robust technology for performing automatic speaker assignment, which can not only avoid inconvenience to the user but also avoid potentially assigning the wrong channels to the speakers in the multi-channel speaker system.

### SUMMARY

According to one aspect of the disclosure, a method for a multi-channel speaker system is provided, wherein the multi-channel speaker system includes N speakers, N≥2. The method may comprise obtaining N! permutations of channel sequence for the N speakers; determining, for each permutation, a voting score that represents the matching degree between the channel sequence indicated in a permutation and a correct channel assignment sequence of the N speakers; selecting the permutation with the highest voting score; and assigning input source channels to the N speakers in the order of the channel sequence indicated in the selected permutation.

According to another aspect of the present disclosure, a multi-channel speaker system is provided. The system may comprise N speakers and a processor. The processor may be configured to obtain N! permutations of channel sequence for the N speakers; determine, for each permutation, a voting score that represents the matching degree between the channel sequence indicated in the permutation and a correct channel assignment sequence of the N speakers; select the permutation with the highest voting score; and assign input source channels to the N speakers in the order of the channel sequence indicated in the selected permutation.

According to yet another aspect of the present disclosure, a non-transitory computer-readable storage medium comprising computer-executable instructions is provided which, when executed by a computer, causes the computer to perform the method disclosed herein.

### BRIEF DESCRIPTION OF THE DRAWINGS

FIG. 1 illustrates an example of the five-speaker system with two internal microphones in each speaker for automatic calibration;

FIG. 2 illustrates an example of the impulse responses of the two microphones located inside speaker A when speaker B was playing a sweep signal, based on the system configuration in FIG. 1;

FIG. 3 illustrates an example of the angle calculating approach between two microphones and a speaker with far-filed model;

FIG. 4 illustrates an example configuration of five-speaker system and four direction angles of far-field speakers;

FIG. 5 illustrates another example configuration of five-speaker system and four direction angles of far-field speakers;

FIG. 6 illustrates a flowchart of the method for a multi-channel speaker system including N speakers according to one or more embodiments of the present disclosure; and

FIG. 7 illustrates a flowchart of the method of calculating voting score for each permutation according to one or more embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified, and details or components are omitted for clarity of presentation and explanation. The drawings and discussion serve to explain principles discussed below, where like designations denote like elements.

### DETAILED DESCRIPTION OF THE PREFERRED EMBODIMENTS

Examples will be provided below for illustration. The descriptions of the various examples will be presented for purposes of illustration but are not intended to be exhaustive or limited to the embodiments disclosed. Many modifications and variations will be apparent to those of ordinary skill in the art without departing from the scope and spirit of the described embodiments.

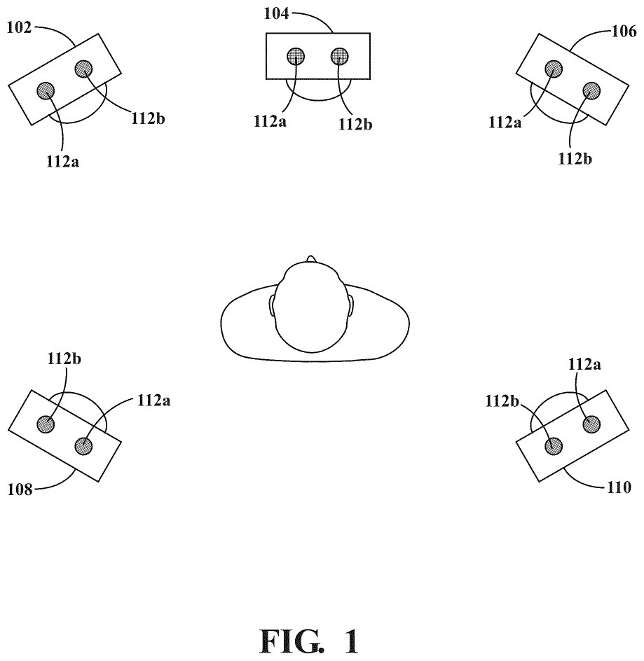

As mentioned above, during the initial setup stage of the multi-channel speaker system, it is inconvenient for the user to confirm the assignment of channels for speakers in the multi-channel speaker system and manually swap the speakers or change their relative positions. In this disclosure, a novel method and system are provided, which may automatically perform speaker assignment and accordingly avoid inconvenience to the user but also ensure assigning the correct channels to the speakers in the multi-channel speaker system. The method and system provided in this disclosure utilize permutations sequence-based algorithm in combination with jointly voting method to provide the best estimation of the speaker placement. In addition, while performing estimation of channel assignment, an acoustic calibration may be automatically performed. Thus, at the initial setup stage of the speaker system, especially for both the channel assignment and the acoustic calibration during the initial setup stage, the impact on the user experience will be minimized. The novel approach will be explained in detail referring to FIGS. 1-7 as follows.

A multi-channel speaker system may include N speakers, such as wireless speakers, wherein N may be greater than or equal to 2. Each speaker in the speaker system may include at least two internal microphones. For the sake of clarity, FIG. 1 shows an example of the five-speaker system with two internal microphones in each speaker for automatic calibration. FIG. 1 illustrates the example arrangement of five speakers 102, 104, 106, 108, 110, which further shows the relative positions of the speakers. As the example shown in FIG. 1, there are two microphones 112a, 112b installed inside each speaker. The automatic calibration may comprise the channel assignment and the acoustic calibration. For example, users may press a button on the speaker or select the calibration feature in a smartphone App to trigger the automatic calibration process. When the calibration process is triggered, each speaker will play a sweep signal in unknown sequence to its position and all the microphones will simultaneously record the sounds from each speaker. The time differences of arrival between microphones in each speaker can be obtained based on the latency between impulse responses of the microphones.

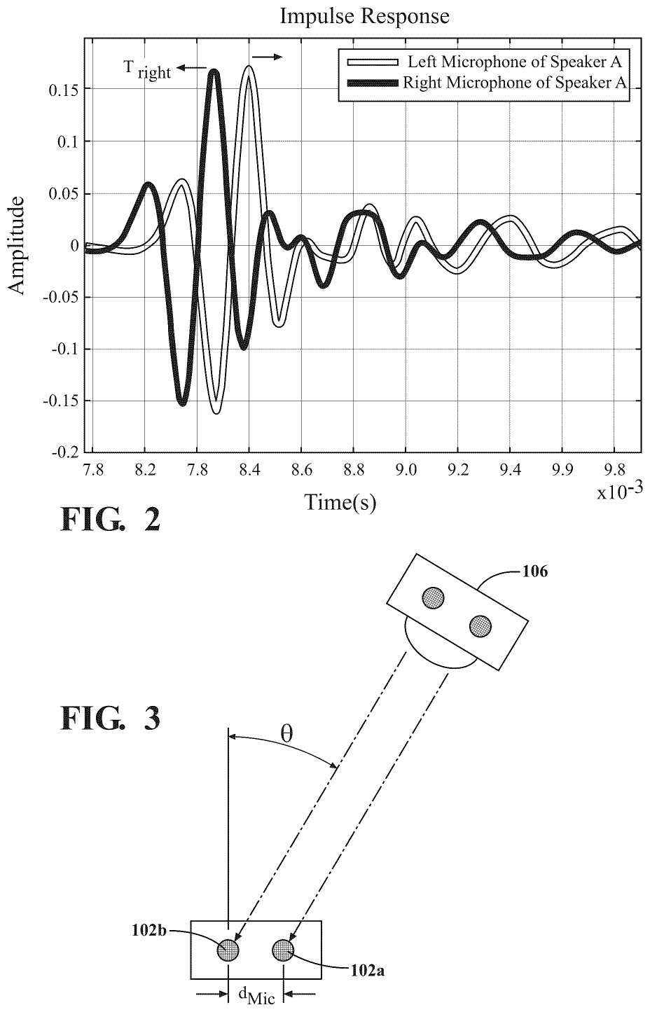

For example, FIG. 2 illustrates an example of the impulse responses of the two microphones 112a, 112b located in speaker A, 102 when speaker B. 104 was playing a sweep signal, based on the system configuration of FIG. 1. Since the speaker B, 104 is on the right side of the speaker A, 102, the right microphone 112b of the speaker A, 102 receives the signal earlier than the left microphone 112a of speaker A 102. As shown in FIG. 2, the latency between the dual-mic impulse responses can be obtained. For example, the latency in this example can be regarded as the time difference T_{diff} of two impulse responses of the speaker A 102, and it can be calculated by

$${T}_{diff} = {T}_{left} - {T}_{right} \qquad ( 1 )$$

where T_{left} and T_{right} are occurrence time of the peaks of the impulse responses of left and right microphones, respectively. For the rest speakers and microphones in the speaker system, time differences can be obtained in the same manner. If the system consists of N speakers, there will be an N×N matrix of time differences. The i^{th} row of the matrix means the i^{th} speaker is playing signal and the j^{th} column of the matrix means the microphones of the j^{th} speaker are recording. In this example, a 5×5 matrix of time differences will be obtained.

After the time differences for each speaker are estimated as described above, the directions of the sound source can be calculated for each speaker, more specifically, the angles of the incoming sounds can be calculated. In theory, there are two models, i.e., near-field and far-field model. For example, in common use case, as the distance of two microphones in one speaker is small (ranging from 5 cm to 40 cm), and usually the speaker distance in the multi-channel speaker system is much bigger (ranging from 1 m to 10 m), the far-field model will be utilized for simplicity in the following descriptions.

FIG. 3 shows an example of the angle calculating approach between two microphones and a speaker with far-filed model. When the speaker in a direction with angle θ plays the signal, which is propagated to the microphones. There will be a latency between the time when the left and right microphones receive the signal because of a distance d_{Mic} between the two microphones. The angle θ can be calculated by,

$$θ = {sin}^{- 1} ( {T}_{diff} * c / {d}_{M i c} ) \qquad ( 2 )$$

where c is the sound speed, T_{diff} is the time difference of two impulse responses of the speaker, which can be calculated according to equation (1). If the system consists of N speakers, there will be an N×N matrix of estimated angles indicating the sound source directions for all the speakers.

If the system consists of N speakers, there should be N! permutations of channel sequence assigned to the speakers. To correctly arrange the channel to the speakers, this disclosure proposes a joint voting method to robustly figure out the correct assignment sequence. According to one or more embodiments, for each permutation, a voting score or rank will be calculated, the voting score or rank may represent the matching degree between the channel sequence indicated in the permutation and a correct channel assignment sequence of the N speakers. For example, the higher the voting score or rank, the better the matching degree. Then, the permutation with the highest voting score will be selected. According to the channel sequence indicated in the selected permutation, input source channels will be assigned to the N speakers in the order of the channel sequence in the selected permutation.

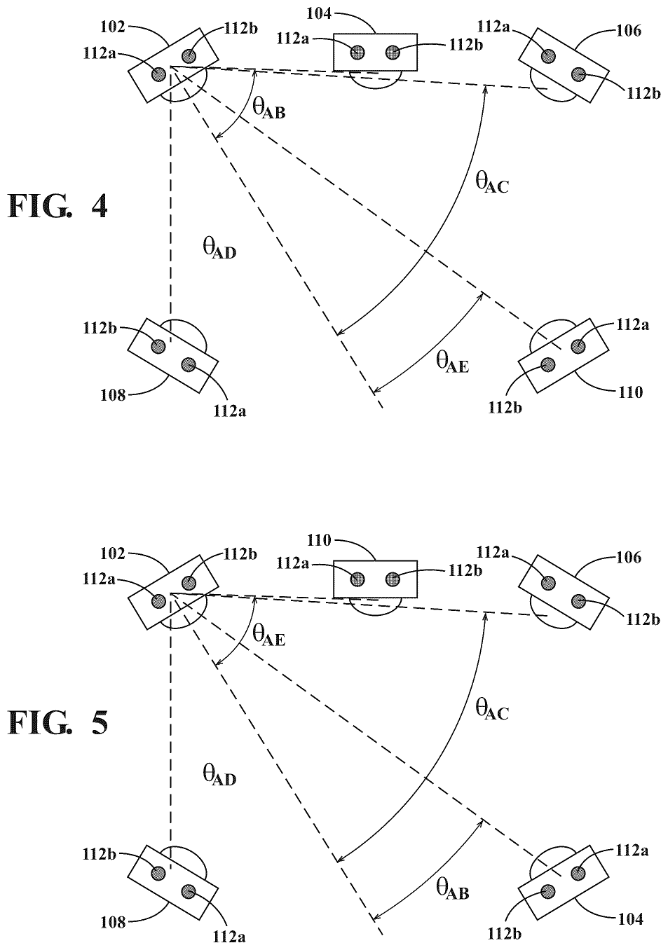

Next, a joint voting method in combination with the permutations sequence-based algorithm will be described in detail in reference to FIG. 4 and FIG. 5.

As an example, FIG. 4 illustrates one configuration of five-speaker system and four direction angles of far-field speakers. This illustrated configuration may be representative of one permutation from N! permutations. In this example, speaker A 102 is recording, speakers B-E 104, 106, 108, 110 as sound sources respectively play a sweep signal in an arbitrary sequence and output sounds. Then, four sound source directions relative to the speaker A 102, i.e., direction angles can be calculated using the method described in reference to FIG. 2 and FIG. 3, the calculated direction angles are expressed such as θ_{AB}, θ_{AC}, θ_{AD}, θ_{AE}. Also, the four sound source directions can reflect the relative positions among the four speakers. For example, θ_{AB} is an angle of incoming sound from the speaker B 104 to the speaker A 102 and is also representative of the position of speaker A 102 being recording relative to the speaker B 104 being playing the sweep signal. θ_{AC} is an angle of incoming sound from the speaker C 106 to the speaker A and is also representative of the position of speaker A 102 being recording relative to the speaker C 106 being playing the sweep signal. θ_{AD} is an angle with negative sign of incoming sound from the speaker D 108 to the speaker A and is also representative of the position of speaker A 102 being recording relative to the speaker D 108 being playing the sweep signal. θ_{AE} is an angle of incoming sound from the speaker E 110 to the speaker A and is also representative of the position of speaker A 102 being recording relative to the speaker E 110 being playing the sweep signal.

Assuming a direction condition for the case of speaker A 102 being recording is as the below condition (Eq. 3), in the configuration shown in the example of FIG. 4, the calculated angles just satisfy the direction condition defined by Eq. 3. Thus, the permutation corresponding to the configuration will be voted correct or with the highest score. In other words, the channel assignment sequence indicated in this permutation will be the correct channel sequence we want to figure out.

$${θ}_{A B} > {θ}_{A C} > {θ}_{A E} > {θ}_{A D} \qquad ( 3 )$$

FIG. 4 only gives a simple example of an ideal situation to illustrate the basic principle of the method of the present disclosure. In the jointly voting method, for each speaker as the speaker being recording, there is a corresponding angle direction condition which should be met when all speakers are in the correct positions or assigned with input source channels in the correct channel assignment sequence. For example, in the example of the five-speaker system shown in FIG. 4, in addition to the condition defined by Eq. 3, there should be a corresponding angle direction condition for the speaker B 104 as the speaker that is recording, a corresponding angle direction condition for the speaker C 106 as the speaker that is recording, a corresponding angle direction condition for the speaker D 108 as the speaker that is recording, and a corresponding angle direction condition for the speaker E 110 as the speaker that is recording. For simplicity, these conditions are omitted to express here. In practice, the direction angle conditions may be not completely satisfied due to unexpected things. Thus, for each speaker in the speaker system, an estimation of the matching degree between the direction angles and the corresponding angle condition as described above will be performed. Based on the estimations for all the speakers, a voting score for each permutation may be determined. The voting score represents the matching degree between a channel sequence indicated in a permutation with a correct channel assignment sequence of all speakers in the speaker system. After the voting scores or ranks are estimated for all the permutations, for example the permutation with the high scores or ranks may be selected. The channel sequence indicated in the selected permutation will be considered as the correct sequence for assigning input source channels.

FIG. 5 illustrates another example with another configuration of five-speaker system and four direction angles of far-field speakers. In this example, speaker A 102 is recording, and speakers B-E 104. 106, 108, 110 as sound sources respectively play a sweep signal in an arbitrary sequence and output sounds. Then, four sound source directions relative to the speaker A 102, i.e., direction angles relative to the speaker A 102 can be calculated using the method described in reference to FIG. 2 and FIG. 3. The calculated direction angles are expressed such as θ_{AB}, θ_{AC}, θ_{AD}, θ_{AE}. It can be seen from FIG. 5 that the speaker B 104 and speaker E are reversed, and it can be understood that such a configuration shown in FIG. 5 corresponds to a different 10 permutation from that in the example shown in FIG. 4. In this situation, the condition (Eq. 3) for the case of speaker A 102 being recorded will not be satisfied. Then, the following estimations will be further performed to determine whether the conditions (not shown) for the cases of speakers B-E 104, 106, 108, 110 respectively being recording are satisfied or determine the matching degrees of these conditions. According to the determined results, this sequence of this configuration will be voted to be incorrect or with a lower score or rank, which means the voting score or rank for the permutation corresponding to the configuration of speakers in FIG. 5 may be lower. Then, the method will try another permutation and perform the similar voting process until all the permutations have been taken into consideration. In this example, the permutation that swaps the angles of B 104 with E 110 will be voted with the highest score, which means all the angle direction conditions are satisfied. Therefore, the original input channel B will be assigned into the actual wireless speaker E, and the original input channel E will be assigned into the actual wireless speaker B 104.

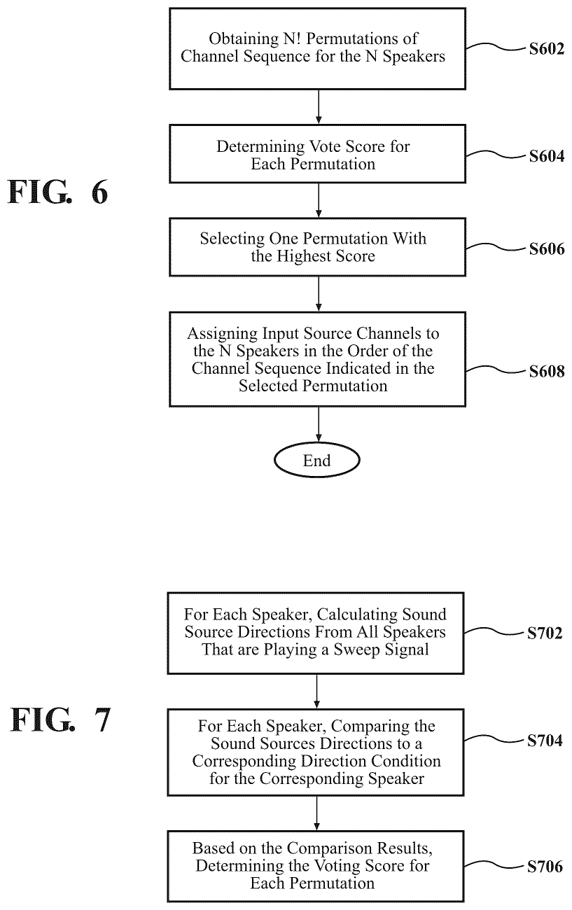

FIG. 6 illustrates a flowchart of the method for a multi-channel speaker system including N speakers according to one or more embodiments of the present disclosure. At S602, N! permutations of channel sequence for the N speakers are obtained. At S604, a joint voting process for each permutation may be performed to determine a voting score. Each voting score represents a matching degree between a channel sequence indicated in the permutation with a correct channel assignment sequence of the N speakers. At S606, one permutation is selected from the determined voting scores. For example, one permutation with the highest voting scores may be selected. At S608, input source channels are assigned to the N speakers in the order of the channel sequence indicated in the selected permutation.

FIG. 7 illustrates a flowchart of the method of calculating a voting score for each permutation according to one or more embodiments of the present disclosure. At S702, for each speaker being recorded, sound source directions from all speakers that are playing the sweep signal are calculated. At S704, for each speaker being recorded, a comparison is performed to determine the matching degree between the sound sources directions and the corresponding direction condition of the corresponding speaker. Thus, comparison results considering all the speakers can be obtained. At S706, based on the comparison results obtained in S704, the voting score for each permutation may be determined.

The above we discussed only take into account the position and channel sequence of the speakers. But in practice, it can be combined with frequency response calibration, which takes advantage of the sweep signal as well. For example, the frequency responses of the speaker A, FR_{A}, and its target frequency responses, FR_{targetA}, are described as below, respectively,

$$F {R}_{A} = \vert FFT ( {h}_{A} ) \vert \qquad ( 4 )$$

$${FR}_{targetA} = \vert FFT ( {h}_{targetA} ) \vert$$

wherein FFT is Fast Fourier Transform and |*| is absolute operator. h_{A} denotes the impulse responses between the microphones and transducers of speaker A in the user's environment, which are discussed as above, for example, discussed in reference to FIGS. 1-2. And h_{targetA} denotes the impulse responses between the microphones and transducers of speaker A in the target environment.

The calibration filter can be obtained by,

$${filter}_{cal} = ℱ ( {FR}_{target} / {FR}_{A} ) \qquad ( 5 )$$

where [symbol] (⋅) is a function that converts the frequency response to the calibration filter, for example, the function of finite impulse response (FIR) filter to infinite impulse response (IIR) filter. Hence, the calibration filter will be inserted and applied to the original audio pipeline. It can be understood that the frequency response calibration discussed above may be applied to all the speakers in the multi-channel speaker system.

The discussed method above may be realized by a processor included in the speaker system. The processor may be any technically feasible hardware unit configured to process data and execute software applications, including without limitation, a central processing unit (CPU), a microcontroller unit (MCU), an application specific integrated circuit (ASIC), a digital signal processor (DSP) chip and so forth.

In this disclosure, a new solution is provided to correctly and automatically arrange input source channels to the speakers in a multi-channel speaker system. In addition, while performing estimation of channel assignment, an acoustic calibration may be automatically performed. Thus, at the initial setup stage of the speaker system, especially for both channel assignment and acoustic calibration during the initial setup stage, the impact on the user experience will be minimized.
1. In some embodiments, a method for a multi-channel speaker system including N speakers, N≥2, the method comprising: obtaining N! permutations of channel sequence for the N speakers; determining, for each permutation, a voting score that represents a matching degree between the channel sequence indicated in the permutation and a correct channel assignment sequence of the N speakers; selecting one permutation with the highest voting scores; and assigning input source channels to the N speakers in the order of the channel sequence indicated in the selected permutation.
2. The method according to clause 1, wherein the determining, for each permutation, a voting score comprises: for each speaker, calculating sound source directions from all speakers that are playing a sweep signal, and comparing the sound sources directions to a corresponding direction condition for the corresponding speaker; and based on comparison results, determining the voting score for each permutation; wherein each corresponding direction condition for each speaker is an angle condition which should be met when all speakers are assigned with input source channels in the correct channel assignment sequence.
3. The method according to any one of clauses 1-2, wherein each speaker in the multi-channel speaker system includes at least two internal microphones.
4. The method according to any one of clauses 1-3, wherein the calculating sound source directions from all speakers that are playing the sweep signal comprises: estimating time differences of arrival of the at least two internal microphones included in each speaker based on sweep signals from all speaker in the multi-channel speaker system; and calculating sound source directions for each speaker based on the estimated time differences of arrival for each speaker.
5. The method according to any one of clauses 1-4, wherein the sound source directions for each speaker are angles of each speaker that is recording the sweep signal relative to other speakers that are playing the sweep signal; and wherein the comparing the sound sources directions to the corresponding direction condition for each speaker comprises: comparing a relation of magnitudes of the angles; and determining the matching degree between the relation of magnitudes of the angles and the corresponding direction condition.
6. The method according to any one of clauses 1-5, wherein the sound sources directions are calculated by the equation as follows:

$$θ = {sin}^{- 1} ( {T}_{d i f f} * c / {d}_{M i c} )$$

wherein T_{diff} is the time difference of arrival of the at least two internal microphones included in each speaker, d_{Mic} is a distance between the at least two internal microphones, and c is a sound speed.
7. The method according to any one of clauses 1-6, wherein the estimating time differences of arrival of the at least two internal microphones included in each speaker based on sweep signals from all speaker in the multi-channel speaker system comprises: estimating time differences of arrival of the at least two internal microphones included in each speaker based on a latency between impulse responses of the at least two internal microphones.
8. The method according to any one of clauses 1-7, further comprises: performing frequency response calibration for each speaker using the sweep signal.
9. A multi-channel speaker system comprising: N speakers, wherein N≥2; and a processor configured to: obtain N! permutations of channel sequence for the N speakers; determine, for each permutation, a voting score that represents a matching degree between the channel sequence indicated in the permutation and a correct channel assignment sequence of the N speakers; select the permutation with the highest voting score; and assign input source channels to the N speakers in the order of the channel sequence indicated in the selected permutation.
10. The multi-channel speaker system according to clause 9, wherein the processor is configured to perform the following for each speaker: calculating sound source directions from all speakers that are playing the sweep signal, and comparing the sound sources directions to a corresponding direction condition for the corresponding speaker; and determine the voting score for each permutation based on comparison results; wherein each corresponding direction condition for each speaker is an angle condition which should be met when all speakers are assigned with input source channels in the correct channel assignment sequence.
11. The multi-channel speaker system according to any one of clauses 9-10, wherein each speaker in the multi-channel speaker system includes at least two internal microphones.
12. The multi-channel speaker system according to any one of clauses 9-11, wherein the processor is further configured to: estimate time differences of arrival of the at least two internal microphones included in each speaker based on sweep signals from all speaker in the multi-channel speaker system; and calculate sound source directions for each speaker based on the estimated time differences of arrival for each speaker.
13. The multi-channel speaker system according to any one of clauses 9-12, wherein the sound source directions for each speaker are angles of each speaker that is recording the sweep signal relative to other speakers that are playing the sweep signal; and wherein the processor is further configured to: compare a relation of magnitudes of the angles; and determine the matching degree between the relation of magnitudes of the angles and the corresponding direction condition.
14. The multi-channel speaker system according to any one of clauses 9-13, wherein the angles are calculated by the equation as follows:

$$θ = {sin}^{- 1} ( {T}_{d i f f} * c / {d}_{M i c} )$$

wherein T_{diff} is the time difference of arrival of the at least two internal microphones included in each speaker, d_{Mic} is a distance between the at least two internal microphones, and c is a sound speed.
15. The multi-channel speaker system according to any one of clauses 9-14, wherein the processor is further configured to: estimate time differences of arrival of the at least two internal microphones included in each speaker based on a latency between impulse responses of the at least two internal microphones.
16. The multi-channel speaker system according to any one of clauses 9-15, wherein the processor is further configured to perform frequency response calibration for each speaker using the sweep signal.
17. A computer-readable storage medium comprising computer-executable instructions which, when executed by a computer, causes the computer to perform the method according to any one of claims 1-8.

The descriptions of the various embodiments have been presented for purposes of illustration but are not intended to be exhaustive or limited to the embodiments disclosed. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments, and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective calculating/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method for a multi-channel speaker system including N speakers, N≥2, comprising the steps of:
obtaining N! permutations of channel sequence for the N speakers;
determining, for each permutation, a voting score that represents a matching degree between the channel sequence indicated in the permutation and a correct channel assignment sequence of the N speakers;
selecting one permutation with the highest voting scores; and
assigning input source channels to the N speakers in the order of the channel sequence indicated in the selected permutation.

2. The method according to claim 1, wherein the step of determining, for each permutation, a voting score comprises:
for each speaker:
calculating sound source directions from all speakers that are playing a sweep signal, and
comparing the sound source directions to a corresponding direction condition for the corresponding speaker; and
based on comparison results, determining the voting score for each permutation;
wherein each corresponding direction condition for each speaker is an angle condition which should be met when all speakers are assigned with input source channels in the correct channel assignment sequence.

3. The method according to claim 1, wherein each speaker in the multi-channel speaker system includes at least two internal microphones.

4. The method according to claim 2, wherein the step of calculating sound source directions from all speakers that are playing the sweep signal further comprises:
estimating time differences of arrival of the at least two internal microphones included in each speaker based on sweep signals from all speakers in the multi-channel speaker system; and
calculating sound source directions for each speaker based on the estimated time differences of arrival for each speaker.

5. The method according to claim 2,
wherein the sound source directions for each speaker are angles of each speaker that is recording the sweep signal relative to other speakers that are playing the sweep signal; and
wherein the step of comparing the sound sources directions to the corresponding direction condition for each speaker further comprises:
comparing a relation of magnitudes of the angles; and
determining the matching degree between the relation of magnitudes of the angles and the corresponding direction condition.

6. The method according to claim 3, wherein the sound source directions are calculated by the equation as follows:
$$θ = {sin}^{- 1} ( {T}_{d i f f} * c / {d}_{M i c} )$$
wherein T_{diff} is the time difference of arrival of the at least two internal microphones included in each speaker, d_{Mic} is a distance between the at least two internal microphones, and c is a sound speed.

7. The method according to claim 4, wherein the step of estimating time differences of arrival of the at least two internal microphones included in each speaker based on sweep signals from all speakers in the multi-channel speaker system comprises the step of:
estimating time differences of arrival of the at least two internal microphones included in each speaker based on a latency between impulse responses of the at least two internal microphones.

8. The method according to claim 1, further comprises the step of:
performing frequency response calibration for each speaker using the sweep signal.

9. A multi-channel speaker system comprising:
N speakers, wherein N≥2; and
a processor configured to:
obtain N! permutations of channel sequence for the N speakers;
determine, for each permutation, a voting score that represents a matching degree between the channel sequence indicated in the permutation and a correct channel assignment sequence of the N speakers;
select the permutation with the highest voting score; and
assign input source channels to the N speakers in the order of the channel sequence indicated in the selected permutation.

10. The multi-channel speaker system according to claim 9, wherein the processor is configured to perform the following for each speaker:
calculate sound source directions from all speakers that are playing the sweep signal, and
compare the sound sources directions to a corresponding direction condition for the corresponding speaker; and
determine the voting score for each permutation based on comparison results;
wherein each corresponding direction condition for each speaker is an angle condition which should be met when all speakers are assigned with input source channels in the correct channel assignment sequence.

11. The multi-channel speaker system according to claim 9, wherein each speaker in the multi-channel speaker system includes at least two internal microphones.

12. The multi-channel speaker system according to claim 11, wherein the processor is further configured to:
estimate time differences of arrival of the at least two internal microphones included in each speaker based on sweep signals from all speakers in the multi-channel speaker system; and
calculate sound source directions for each speaker based on the estimated time differences of arrival for each speaker.

13. The multi-channel speaker system according to claim 12,
wherein the sound source directions for each speaker are angles of each speaker that is recording the sweep signal relative to other speakers that are playing the sweep signal; and
wherein the processor is further configured to:
compare a relation of magnitudes of the angles; and
determine the matching degree between the relation of magnitudes of the angles and the corresponding direction condition.

14. The multi-channel speaker system according to claim 13, wherein the angles are calculated by the equation as follows:
$$θ = {sin}^{- 1} ( {T}_{d i f f} * c / {d}_{M i c} )$$
wherein T_{diff} is the time difference of arrival of the at least two internal microphones included in each speaker, d_{Mic} is a distance between the at least two internal microphones, and c is a sound speed.

15. The multi-channel speaker system according to claim 14, wherein the processor is further configured to:
estimate time differences of arrival of the at least two internal microphones included in each speaker based on a latency between impulse responses of the at least two internal microphones.

16. The multi-channel speaker system according to claim 9, wherein the processor is further configured to perform frequency response calibration for each speaker using the sweep signal.
